(19) United States
(12) Patent Application Publication
(10) Pub. No.: US 2014/0375594 A1
(43) Pub. Date: Dec. 25, 2014

(54) TOUCH SCREEN SYSTEM AND METHOD

(71) Applicant: Texas Instruments Incorporated, Dallas, TX (US)

(72) Inventor: Arthur John Redfern, Plano, TX (US)

(21) Appl. No.: 13/924,771

(22) Filed: Jun. 24, 2013

(51) Int. Cl. G06F 3/044

(52) U.S. Cl. CPC G06F 3/044
USPC 345/174

(57) ABSTRACT

A method of operating a touch screen system having a plurality of screen nodes that includes collecting touch data from the screen nodes indicative of the number of touches received by each node and determining a nonuniform sampling sequence for the touch screen based on the collected touch data.

### BACKGROUND

Touch screens are used in smart phones, tablet computers and many other modern electronic devices. Touches to a touch screen are sensed by sensing changes in parameters caused by the touch. Earlier touch screens usually sensed changes in resistance. Newer touch screens usually sense changes in capacitance resulting from a touch. Capacitive touch screens have grids of underlying sensors or “nodes” which generate signals indicative of the capacitance, etc. at the node.

Using a traditional uniform sampling sequence, each of the nodes are read out or “sampled” once during each panel scan. The read outs would then be used together to determine the location of touches. Method and apparatus for performing the basic operations described above are known in the art. See, for example, C. Luo, M. Borkar, A. Redfern and J. McClellan “Compressive Sensing for Sparse Touch Detection on Capacitive touch Screens,” IEEE Journal On Emerging And Selected Topics In Circuits And Systems, Vol. 2, No. 3, September 2012, which is hereby incorporated by reference for all that it discloses.

Operating systems and applications on devices with touch screens typically have one or more of the following characteristics:

1. Only a small number of locations on the screen that are responsive to touches (e.g., a few buttons in the corner).

2. Some locations on the screen are more likely than others to be touched (e.g., specific keys of an onscreen keyboard, the icons on a home screen).

3. A few types of gestures are more commonly used than others (e.g., a motion control in a game or a zoom operation in a picture application).

These characteristics can change from application to application and from operating system to operating system.

### BRIEF DESCRIPTION OF THE DRAWINGS

FIG. 1 is a block diagram showing functional layers of a touch screen system of the present disclosure.

FIG. 2 is a schematic drawing of a touch screen used in the touch screen system of FIG. 1.

FIG. 3 is an example of a histogram generated by the touch screen system of FIGS. 1 and 2.

FIG. 4 is an example of a contour map of the touch screen of FIG. 2 that may be generated using a histogram such as shown in FIG. 3.

FIG. 4A is a legend for the contour map of FIG. 4.

FIG. 5 is a diagram of example touch system operating states and associated histograms.

FIG. 6 is a schematic diagram of one example embodiment of a touch screen system

FIG. 7 is a flow diagram of an example method of operating a touch screen system.

FIG. 8 is a flow diagram of another example embodiment of a method of operating a touch screen system.

### DETAILED DESCRIPTION

This specification, in general, discloses a touch screen system 10. The touch screen system 10, as shown in FIG. 6, includes a touch screen 12 that has a plurality of screen sensors or nodes 50, FIG. 2. The nodes 50 generate sensing signals that indicate when a screen node 50 has been touched. A touch screen controller 14 receives the touch screen sensing signals and generates touch screen data therefrom which is stored in a memory 60, which may be part of the touch screen controller. The touch screen controller 14 samples the touch sensing signals in a nonuniform sequence based upon the touch data stored in the memory 60.

The phrase “uniform sampling sequence,” as used in this specification means a sampling sequence in which each node of a touch screen is sampled the same number of times per panel scan. The phrase “nonuniform sampling sequence,” means a sampling sequence in which different nodes are sampled more or less frequently than others per panel scan.

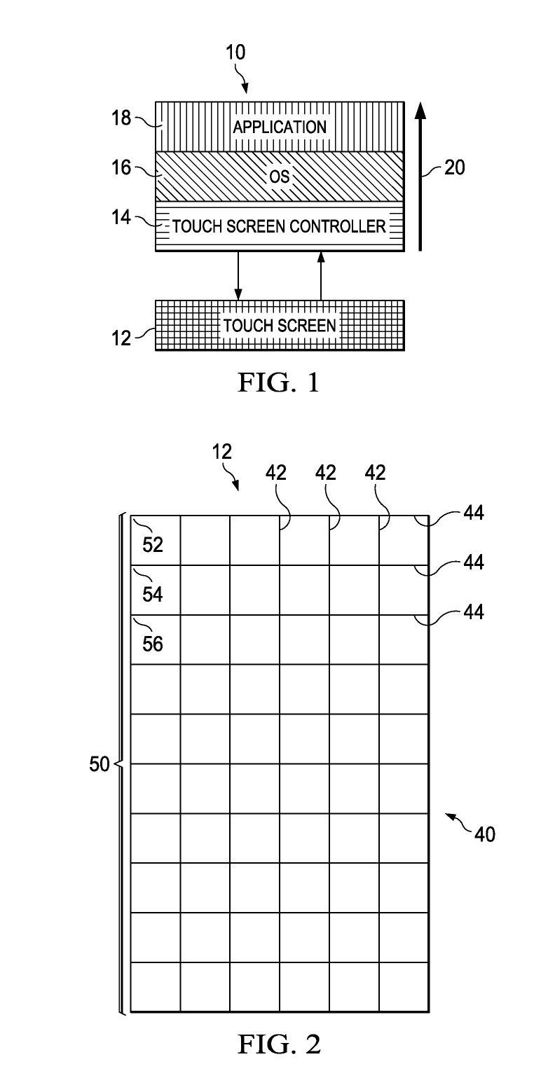

As shown by FIG. 1, as viewed from a layered perspective, a touch screen system 10 includes a touch screen layer 12, a touch screen controller layer 14, an operating system (“OS”) layer 16 and an applications layer 18. The touch screen controller layer 14 drives the touch screen layer 10. The controller layer 14 also senses changes in a touch screen electrical parameter, such as resistance or capacitance, which result from touches. These changes in the electrical parameter are converted to touch location, shape and strength information in the touch screen controller layer 14 and are then passed to the OS layer 16. After receiving this information the OS layer 16 compiles the information into touch and gesture events. The applications layer 18 uses the touch and gesture events to control the operation of the applications layer 18. Information primarily flows in one direction 20: touch screen controller 14 to OS 16 to application 18.

In many traditional touch screen implementations the capacitance of some nodes changes more frequently than other nodes due to the fact that some nodes are touched more frequently than other nodes. There are a number of reasons why it may be desirable to sample the more frequently touched nodes more often than infrequently touched modes. One reason is that by sampling low probability nodes less frequently, less energy is required. Another reason is that by frequently sampling nodes with a high probability of being touched, the performance of the system can be improved. For example, when typing with an on-screen keyboard the typed material would appear on the touch screen more quickly if the screen areas associated with the keyboard were sampled more frequently . Sampling different nodes with different frequencies is referred to herein as “nonuniform sampling.”

It is common for the component layers of a touch screen system to be made by separate vendors. In view of the multiple vendors involved with the multiple layers of a touch screen system, it would be desirable to obtain information on the likelihood of a node being touched at the touch screen controller level. An initial question is thus how can this side information of the likelihood of a node being touched be obtained at the touch screen controller level 14 without coordination at the OS level 16 or the application level 18. Answers to this question are provided below.

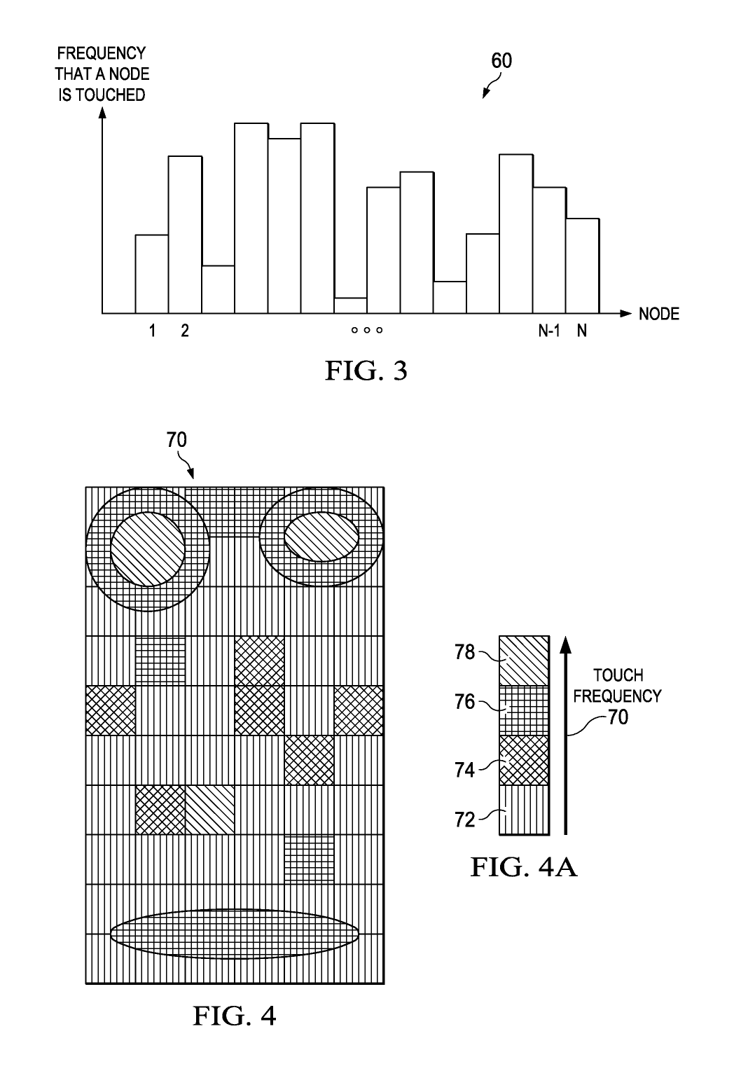

One way of determining the likelihood that a particular part of a touch screen will be touched in the future is to determine how often it has been touched in the past. FIG. 2 illustrates a rectangular screen grid 40 of touch screen 10. The screen grid 40 comprises a plurality of touch sensors or nodes 50, including individual nodes 52, 54, 56, etc. arranged in rectangular grid with columns 42 and rows 44. Each of the nodes produces a signal representative of a change in an electrical parameter, e.g. capacitance that is produced by a touch of the screen in the region of the node 50. This touch information can be collected and stored in a memory with a histogram or other data collection means. FIG. 3 is one embodiment of a histogram 60 that may be produced from touches on the nodes 50 of a screen grid 40. The horizontal axis of the graph represents each of the 1 . . . N screen nodes. The vertical axis of the graph indicates the number of touches to each node over some predetermined period. Each time that a node 50 is touched during this predetermined period, its corresponding histogram bin is updated. Time can be added to this updating process by applying a forgetting factor to each bin or a normalization factor.

The histogram bin values are then mapped to a likelihood or frequency with which a node 50 will be sampled during the next panel scan: nodes with higher histogram values are sampled more frequently, nodes with lower histogram values are sampled less frequently. Different mapping are possible and bounds can be placed on the highest and lowest sampling frequencies for different nodes. Regardless of the specific method used for updating the histogram 60, the result is that the histogram provides a value correlated to the relative frequency that a node will be touched based on past touches. In slightly different words, the more often a node was touched in the past, the more likely it is assumed to be touched in the future, in a similar operating environment.

FIG. 4 is one example of a contour map 70 for a touch screen, such as touch screen 12 of FIGS. 1 and 2, produced from a histogram 60 like that shown in FIG. 3. The shading in FIG. 4 indicates the probability of individual nodes within a particular shaded area being touched, based upon the information in the histogram 60 of FIG. 2. FIG. 4A is a key to the touch frequency shadings of FIG. 4. The relative frequencies are arranged in ascending order 70 including: low 72, low-moderate 74, high-moderate 76 and high 78.

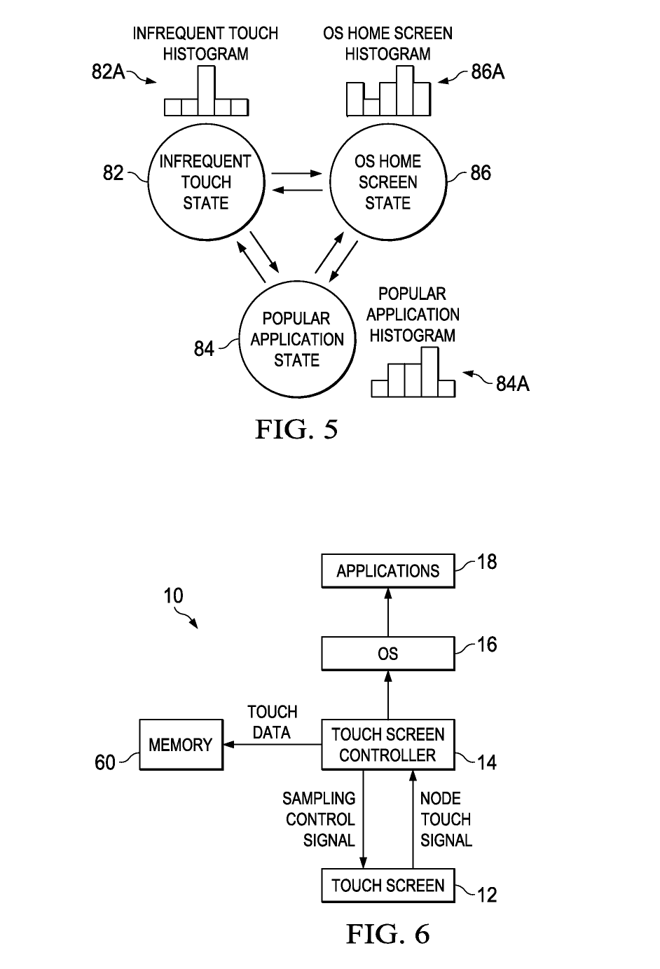

The histogram idea can be expanded upon to recognize different states of use for the touch screen 12. For example, as shown by FIG. 5, when waking up from a sleep state 82 a specific portion of a screen may be more likely to be touched to unlock the device. The corresponding histogram may look like 82A. Likewise, if a specific gesture is recognized, then the subsequent likelihoods of touches may be different than if a different gesture was recognized and the controller recognizes that the touch screen is in a popular applications state 86 in which that specific gesture is used often. The corresponding histogram may look like 86A. If particular areas on the screen associated with application icons are touched frequently, this state might be identified as an OS home screen state 84 and may have a histogram looking like 84A In other words patterns in the histogram data can be recognized to define different states associated with different touch patterns.

States can thus be taken advantage of by storing more than one histogram of touch frequencies and switching between these histograms based on the current state of operation. The current state can be determined by a variety of means including:

1. Not observing any touches for a prolonged period of time to recognize a sleep state.

2. Comparing the current histogram to the saved histograms for the different states and choosing the state with the closest associated histogram as the current state.

New states can also be recognized by not finding a close match between the current histogram and any of the saved histograms.

Compressive sensing seeks to sample a signal at the underlying information rate rather than the signal bandwidth. In the IEEE article of Lou, et al., incorporated by reference above, it is shown that for a touch screen, the sampling rate can be made proportional to the number of fingers touching the screen rather than the number of nodes. Compressive sensing algorithms usually use iterative methods to take advantage of the sparsity assumption and recover the original signal. The performance of these iterative recovery methods could be improved through better initializations if the approximate locations of the touches were known ahead of time. The above described use of histograms determines the likelihood of a node being touched. As such, this can be used as an initialization for iterative compressive sensing signal recovery algorithms by choosing the most likely to be touched nodes as the initial nonzero locations in a recovery algorithm. Such recovery algorithms are known in the art as indicated, for example, in J. Tropp and A. Gilbert, “Signal recovery from random measurements via orthogonal matching pursuit,” IEEE Transactions on Information Theory, vol. 53, no. 12, pp. 4655-4666, Dec. 2007, which is hereby incorporated by reference for all that it discloses.

It will be appreciated from the above disclosure that the use of nonuniform sampling sequences can optimize the responsiveness and power of a touch screen controller 14 by reducing the sampling of nodes 50 that are unlikely to be touched and increasing the sampling of nodes 50 that are likely to be touched. Histograms 60 may be used for tracking the likelihood of a node 50 being touched and to determine the subsequent nonuniform sampling sequence, such as shown in FIG. 4. Histograms 60 can also be used to define multiple states 82, 84, 86, FIG. 5, of a touch screen 12 that can be compared to a current state to select a nonuniform sampling sequence associated with a matched state. Histograms can also be used to determine one or more useful initialization points for compressive sensing sparse touch recovery algorithms. The data needed for determining such nonuniform sampling sequences, in one embodiment, is gathered entirely at the touch screen controller layer 14, thus simplifying the implementation of the system because cooperation and information from multiple vendors associated with the OS layer 16 and the applications layer 18 is not needed.

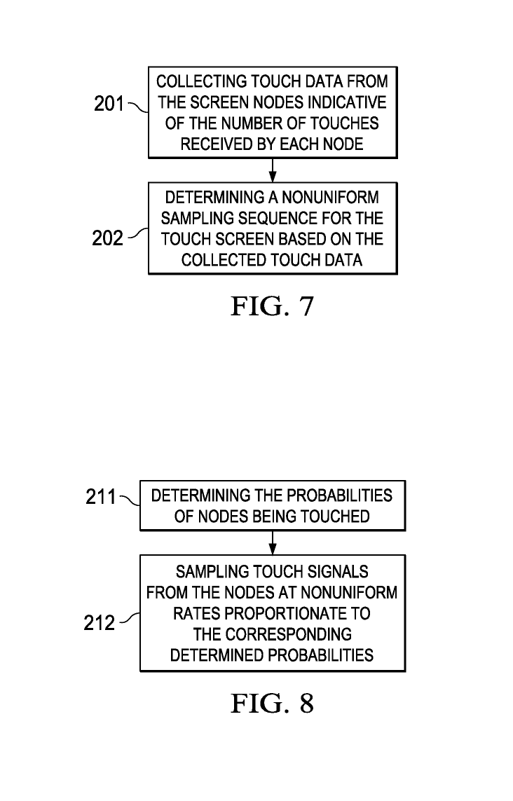

It will be appreciated from the above that, as shown in FIG. 7, one method of operating a touch screen system having a plurality of screen nodes may comprise collecting touch data from the screen nodes indicative of the number of touches received by each node, block 201; and determining a nonuniform sampling sequence for the touch screen based on the collected touch data, block 202.

It will also be appreciated that, as shown in FIG. 8, a method of operating a touch screen with a plurality of touch screen nodes may include determining the probabilities of nodes being touched, block 211, and sampling touch signals from the nodes at nonuniform rates proportionate to the corresponding determined probabilities, block 212.

While certain methods and apparatus are expressly described in detail herein, variations of these methods and apparatus will be obvious to those skilled in the art after reading this disclosure. It is intended that the appended claims be broadly construed to cover all such alternative embodiments, except as limited by the prior art.

What is claimed is:

1. A method of operating a touch screen system having a plurality of screen nodes comprising:
collecting touch data from the screen nodes indicative of the number of touches received by each node; and
determining a nonuniform sampling sequence for the touch screen based on the collected touch data.

2. The method of claim 1 comprising using the collected touch data to define a plurality of touch screen operating states.

3. The method of claim 2 comprising using different nonuniform sampling sequences for different touch screen operating states.

4. The method of claim 3 comprising defining a sleep operating state when no touch data is collected for a predetermined period of time.

5. The method of claim 3 further comprising determining which of the defined operating states corresponds to the current touch screen operating state by comparing data from the current touch screen operating state to data associated with each of the defined touch screen operating states based upon predetermined criteria.

6. The method of claim 5 wherein said comparing data from the current touch screen operating state to data associated with each of the defined touch screen operating states comprises comparing said data based upon the number of touches per unit of time.

7. The method of claim 5 wherein said comparing data from the current touch screen operating state to data associated with each of the defined touch screen operating states comprises comparing said data based upon the time measured between touches.

8. The method of claim 5 comprising defining a new operating mode when said comparing data does not indicate a match according to said predetermined criteria.

9. The method of claim 1 wherein determining a nonuniform sampling sequence for the touch screen based on the collected touch data comprises determining a plurality of nodes that are most likely to be touched and using the plurality of nodes as initial nonzero locations for a compressive sensing sparse touch recovery algorithm.

10. The method of claim 1 wherein said determining a nonuniform sampling sequence for the touch screen based on the collected touch data comprises sampling a node with associated touch data indicating a relatively lower number of touches less frequently than a node with associated touch data indicating a relatively larger number of touches.

11. The method of claim 1 wherein said collecting touch data from the screen nodes indicative of the number of touches received by each node comprises assigning touch data collected from each screen node to a histogram bin associated with that screen node.

12. The method of claim 11 comprising updating the histogram bin corresponding to a screen node each time that screen node is touched.

13. A touch screen system comprising:
a touch screen having a plurality of screen nodes that generate touch sensing signals indicative of each touch received; and
a touch screen controller that receives said touch sensing signals and generates touch data indicative thereof, that stores said touch data in a memory, and that samples said touch sensing signals in a nonuniform sequence based upon said touch data stored in said memory.

14. The touch screen assembly of claim 13 wherein said accumulated touch data indicates the number of touches received by each of said screen nodes.

15. The touch screen assembly of claim 14 wherein said touch screen controller more frequently samples touch sensing signals from screen nodes with associated touch data indicating a relatively larger number of touches than screen nodes with associated touch data indicating a relatively smaller number of touches.

16. The touch screen assembly of claim 13 wherein said memory comprises a histogram bin associated with each of said screen nodes.

17. The touch screen assembly of claim 13 said sampling of said touch sensing signals in a nonuniform sequence based upon said touch data stored in said memory comprises determining a plurality of nodes that are most likely to be touched and using the plurality of nodes as initial nonzero locations for a compressive sensing sparse touch recovery algorithm

18. The touch screen assembly of claim 13 wherein said accumulated touch data is processed to determine the number of fingers currently touching said touch screen.

19. The touch screen assembly of claim 16, at least one node indicated by the histogram as among a predetermined number of modes most likely to be touched being selected as at least one nonzero location for a compressive sensing sparse touch recovery algorithm.

20. A method of operating a touch screen with a plurality of touch screen nodes comprising determining the probabilities of nodes being touched and sampling touch signals from the nodes at nonuniform rates proportionate to the corresponding determined probabilities.
